(19) United States
(12) Patent Application Publication
(10) Pub. No.: US 2015/0073993 A1
(43) Pub. Date: Mar. 12, 2015

(54) SAVINGS SWEEP PROGRAM

(71) Applicant: BANK OF AMERICA CORPORATION, Charlotte, NC (US)

(72) Inventors: Francisco Sebastian Robelo, Charlotte, NC (US); Yog Hari, Charlotte, NC (US); Doris M. Garrett, Walnut Creek, CA (US)

(21) Appl. No.: 14/546,812

(22) Filed: Nov. 18, 2014

Related U.S. Application Data
(63) Continuation of application No. 12/323,097, filed on Nov. 25, 2008.

(51) Int. Cl. G06Q 20/10; G06Q 20/38

(52) U.S. Cl. CPC G06Q 20/10; G06Q 20/38
USPC 705/44

(57) ABSTRACT

Embodiments of the invention provide systems, methods, and computer program products for distributing money between a first account, such as a checking account, and a second account, such as a savings account. Embodiments generally involve determining an upper limit and lower limit associated with the first account, and sweeping funds from the second account into the first account when funds in the first account equal or fall below the lower limit. Funds are swept from the second account into the first account until the funds in the first account are above the lower limit and below or equal to the upper limit. In one embodiment, a target balance is determined between the lower and upper limits, and sweeping funds from the second account into the first account comprises sweeping funds until the funds in the first account equal the target balance. The upper limit, lower limit, and target balance may be defined by the account owner.

### CLAIM OF PRIORITY UNDER 35 U.S.C. §119

This application is a continuation of, and claims priority to, co-pending U.S. patent application Ser. No. 12/323,097, filed on Nov. 25, 2008 and entitled “Savings Sweep Program,” assigned to the assignee hereof and hereby expressly incorporated by reference herein.

### FIELD

This invention relates generally to the field of savings accounts, and more particularly, some embodiments of the invention relate to systems, methods, and computer program products for transferring and sweeping money between checking and savings accounts.

### BACKGROUND

Regulation D in Title 17 of the Code of Federal Regulations (“Regulation D”), in part regulates the reserves that a depository institution is required to maintain for the purpose of facilitating the implementation of the Federal Reserve System's monetary policy. Generally, a portion of Regulation D prevents Small Business Associations (“SBAs”) from having interest-bearing checking accounts, with the exception of some Sole Proprietorships and Non-Profit organizations. Additionally, these interest bearing checking accounts provide a return-on-investment that is very low. To earn significantly more interest on cash deposited into a bank while maintaining liquidity, SBAs have turned to utilizing savings or money market accounts (“MMAs”) that are linked with their checking accounts. While these types of linked accounts provide the benefits of increased interest rates and a small loss in liquidity, they also come with limitations imposed by Regulation D.

Under Regulation D, a monthly limit is placed on the number of transfers a user may make from a savings account or MMA without physically being present. Thus, the transfers that fall under the limit in Regulation D, include internet banking, telephone banking, overspend transfers, transfers made on the account holder's behalf by a member service representative, or automatic scheduled recurring transfers. These transactions are limited to six per month per account. The six per month is further limited, in that only three may be made by check. On the other hand, there are a number of transactions that are not affected by Regulation D. These include ATM transactions, transfers made to University Federal Credit Union (“UFCU”) loans, transactions done in person at a branch, transactions sent in by mail with an original signature, and UFCU bill pay.

SBAs often have large sums of money deposited or withdrawn from checking accounts, due to activities such as account payments from customers, salary payments to employees, inventory purchase payments, or the like. Therefore, these SBAs will often have large sums of money on hand for days or weeks at a time sitting in a checking account earning no interest. This opportunity cost results in the SBAs losing out on additional interest by not investing the cash in a savings account for a period of time before a large payment must be made.

The need exists for a system and process to maximize the interest earned on businesses cash deposits, while still maintaining liquidity, and operating within regulation guidelines.

### BRIEF SUMMARY

Embodiments of the present invention address the above needs and/or achieve other advantages by providing a method, system, computer program product, or a combination of the foregoing and apparatus for transferring and sweeping money between two accounts.

One embodiment of the invention is a system comprising a memory system communicably coupled to a processing system. The memory system comprises information stored therein about a first account, a second account, and an upper limit and lower limit associated with the first account. The processing system is configured to sweep funds from the second account into the first account when funds in the first account equal or fall below the lower limit, and wherein the processing system is configured to sweep funds from the second account into the first account until the funds in the first account are above the lower limit and below or equal to the upper limit.

In another embodiment of the invention, the processing system is further configured to transfer funds from the first account to the second account when funds in the first account are above or equal to the upper limit.

In further accord with an embodiment of the invention, the processing system is configured to transfer funds from the first account into the second account until the funds in the first account are below or equal to the upper limit.

In further accord with an embodiment of the invention, the processing system is configured to transfer funds from the first account to the second account when funds in the first account are above or equal to the upper limit at one or more specific pre-determined times during a day.

In another embodiment of the invention, the memory system stores information stored about a target balance associated with the first account. The target balance is greater than the lower limit and less than the upper limit. The processing system is configured to sweep funds from the second account into the first account until the funds in the first account are equal to the target balance.

In another embodiment of the invention, the values of the upper limit, lower limit, and target balance are defined by an owner of the first account.

In yet another embodiment of the invention, the processing system is configured to automatically determine a value for the upper limit, lower limit, or target balance based at least partially on information about the first account.

In further accord with an embodiment of the invention, the values of the upper limit and lower limit are defined by an owner of the first account.

In another embodiment of the invention, the processing system is configured to automatically determine a value for the upper limit or lower limit based at least partially on information about the first account.

In further accord with an embodiment of the invention, the first account comprises a checking account and the second account comprises an interest-bearing savings account.

In another embodiment of the invention, the processing device is configured to sweep funds from the second account into the first account a maximum pre-determined number of times within a cycle. The processing device is configured to sweep all funds in the second account into the first account when the maximum pre-determined number of sweeps occurs within a cycle.

Another embodiment of the invention, is a method implemented by a computerized apparatus configured for distributing money between a first account and a second account. The method comprises determining an upper limit and a lower limit associated with the first account. After the limits are determined, sweeping the funds from the second account into the first account when funds in the first account equal or fall below the lower limit, until the funds in the first account are above the lower limit and below or equal to the upper limit.

In another embodiment of the invention, the method further comprises transferring funds from the first account to the second account when funds in the first account are above or equal to the upper limit.

In further accord with an embodiment of the invention, the method comprises transferring funds from the first account into the second account until the funds in the first account are below or equal to the upper limit.

In another embodiment of the invention, the method comprises transferring funds from the first account to the second account when funds in the first account are above or equal to the upper limit at one or more specific pre-determined times during a day.

In yet another embodiment of the invention, the method comprises determining a target balance associated with the first account. The target balance is greater than the lower limit and less than the upper limit. The method then comprises sweeping the funds from the second account into the first account until the funds in the first account are equal to the target balance.

In further accord with an embodiment of the invention, the method comprises receiving values of the upper limit, lower limit, and target balance from a user interface.

In another embodiment of the invention, when determining an upper limit and a lower limit associated with the first account, the method comprises receiving the values of the upper limit and lower limit from a user interface.

In another embodiment of the invention, when determining an upper limit and a lower limit associated with the first account, the method comprises automatically generating a value for the upper limit or lower limit based at least partially on information about the first account.

In further accord with an embodiment of the invention, the first account comprises a checking account and the second account comprises an interest-bearing savings account.

In another embodiment of the invention, the method further comprises sweeping all funds in the second account into the first account when a maximum pre-determined number of sweeps occurs within a cycle.

Another embodiment of the invention is a system for a financial institution, which links a customer's checking and savings accounts to distribute money between the accounts. The system comprises a computer-readable medium providing computer-readable instructions and a processor operatively coupled to the computer-readable medium. The processor is configured to execute the computer-readable instructions to receive inputs setting an upper limit, and a lower limit for the balance in a checking account. The process is also configured to sweep funds from a savings account into a checking account, when the balance of the checking account falls below the lower limit until the new balance of the checking account is a value between the upper limit and the lower limit.

In further accord with an embodiment of the invention, the processor is configured to execute the computer-readable instructions to transfer the amount of funds in the checking account above the upper limit from the checking account to the savings account, when the funds in the checking account reach a value greater than the upper limit.

In another embodiment of the invention, the processor is configured to execute the computer-readable instructions to sweep all of the funds in the savings account to the checking account after a pre-determined number of sweeps has occurred within a cycle.

In one embodiment of the invention, the pre-determined number of sweeps is six.

In another embodiment of the invention, the cycle is a month.

In yet another embodiment of the invention, the processor is configured to execute the computer-readable instructions to transfer the amount of funds above the upper limit in the checking account from the checking account to the savings account after a cycle ends.

In further accord with an embodiment of the invention, the processor is configured to execute the computer-readable instructions to receive an input for a desired target balance between the upper limit and the lower limit.

In another embodiment of the invention, the desired target balance is the value between the upper and lower limits of the checking account after the funds have been swept into the checking account from the savings account.

In one embodiment of the invention, the inputs are set by a customer.

In another embodiment of the invention, the system further comprises middleware, a systems of access, a core deposit system, a retrieval application, a customer notification engine, a history warehouse, a customer warehouse, or a transaction authorization system.

Another embodiment of the invention is a method for distributing money between a checking and savings account. The method comprises receiving inputs setting an upper limit and a lower limit for the balance in a checking account. After the inputs are received, then sweeping funds from a savings account into a checking account when the balance of the checking account falls below the lower limit until the new balance in the checking account is a value between the upper limit and the lower limit.

In further accord with another embodiment of the invention, the method comprises moving the amount of funds above the upper limit from the checking account to the savings account when the funds in the checking account reach a value greater than the upper limit.

In another embodiment of the invention, the method further comprises sweeping all of the funds in the savings account to the checking account after a pre-determined number of sweeps has occurred within a defined cycle.

In yet another embodiment of the invention, the method further comprises moving the amount of funds above the upper limit from the checking account to the savings account after a cycle ends.

In one embodiment of the invention, receiving an input further comprises receiving an input for a desired target balance between the upper limit and the lower limit.

In further accord with an embodiment of the invention, the desired target balance is the value between the upper and lower limits of the checking account after the funds have been swept into the checking account from the savings account.

In another embodiment of the invention, the inputs are set by a customer.

Another embodiment of the invention is a computer program product for a savings sweep account. The computer program product comprises a computer-readable medium having computer-readable program code portions embodied therein. The computer-readable program code portion comprises a first executable portion and a second executable portion. The first executable portion is configured for receiving input values for an upper limit and a lower limit for the balance in a checking account. The second executable portion is configured for sweeping funds from a savings account into a checking account when the balance of the checking account falls below the lower limit until the new balance of the checking account is a value between the upper and lower limits.

In further accord with an embodiment of the invention, the computer program product further comprises an executable portion configured for moving the amount of funds above the upper limit from the checking account to the savings account when the funds in the checking account reach a value greater than the upper limit.

In one embodiment of the invention, the computer program product further comprises an executable portion configured for sweeping all of the funds in the savings account to the checking account after a pre-determined number of sweeps has occurred within a cycle.

In another embodiment of the invention, the cycle is a month.

In yet another embodiment of the invention, the computer program product further comprises an executable portion configured for receiving an input for a desired target balance between the upper limit and the lower limit.

In another embodiment of the invention, the desired target balance is the value between the upper and lower limits of the checking account after the funds have been swept into the checking account from the savings account.

In further accord with an embodiment of the invention, the inputs are set by a customer.

Another embodiment of the invention is a system comprising a memory system operatively coupled to a processing system. The memory system comprises storing information about a first account, a second account, and an upper limit, a lower limit, and target balance associated with the first account. The target balance is defined below the upper limit and above the lower limit. The processing system is configured to sweep funds from the second account into the first account when funds in the first account equal or fall below the lower limit. The processing system is configured to sweep funds from the second account into the first account until the funds in the first account are equal to the target balance.

In further accord with an embodiment of the invention, the processing system is configured to transfer funds from the first account into the second account when the funds in the first account are above the upper limit until the funds in the first account are below or equal to the upper limit.

In one embodiment of the invention, the first account is a checking account.

In another embodiment of the invention, the second account is a savings account.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a flow chart outlining the savings sweep process, in accordance with one embodiment of the invention;

FIG. 2 illustrates an example of the savings sweep process, in accordance with one embodiment of the invention; and

FIG. 3 provides a banking environment illustrating the systems relating to the small business savings sweep accounts and how they interact, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although the embodiments of the invention described herein are generally described as involving a “bank,” one of ordinary skill in the art will appreciate that other embodiments of the invention may involve other businesses or financial institutions that take the place of or work in conjunction with the bank to perform one or more of the processes or steps described herein as being performed by a bank.

As will be appreciated by one of skill in the art, the present invention may be embodied as a method, system, computer program product, or a combination of the foregoing. Accordingly, embodiments of the present invention may take the form of an entirely hardware embodiment, an entirely software embodiment (including firmware, resident software, micro-code, or the like), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in computer memory.

Computer program code/computer-readable instructions for carrying out operations of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process, such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

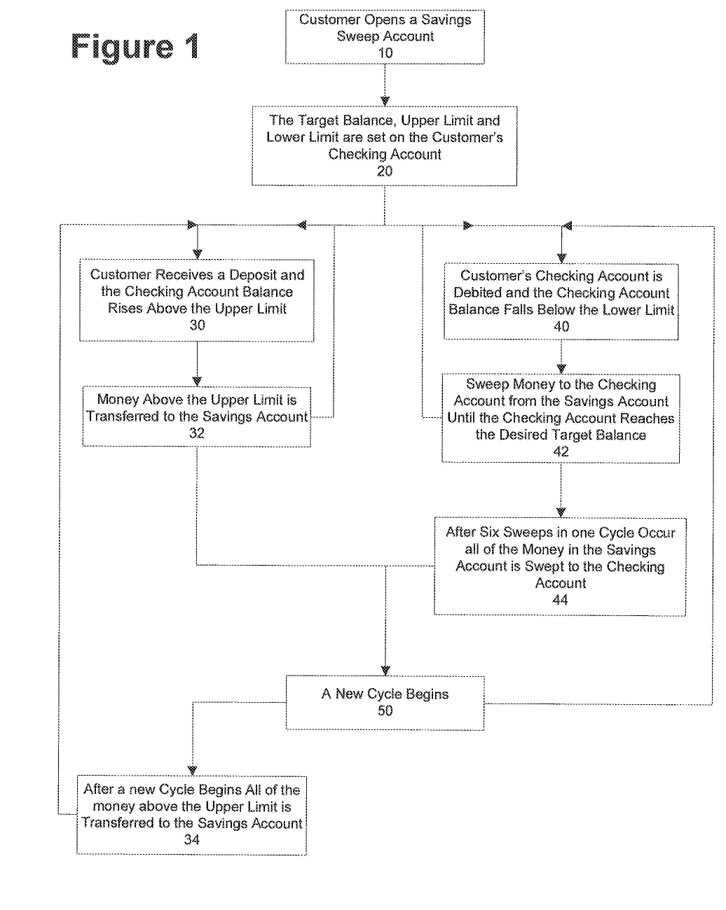

FIG. 1 illustrates a flow chart of the savings sweep process in accordance with an embodiment of the invention. As illustrated in block 10, the customer will generally begin by opening a savings sweep account. The customer will then either set the desired target balance, the upper limit, and lower limit in the checking account, as illustrated in block 20, or some or all of the values will be set automatically for the customer. For example, the upper limit or desired target balance may be set automatically as the current balance in the checking account or as the average balance in the account over a period of time. In another example, the upper and lower limits may be set as a range according to the average amount of funds in the account over a specific period of time. In one embodiment, the target balance and the upper balance are automatically the same number, while, in other embodiments, the upper balance and the target value are different user-defined or automatically determined numbers. In one embodiment, the desired target balance is defaulted to or automatically set as the average of the upper and lower limits. As such, it shall be understood that, in some instances, the desired target balance, the upper limit, and the lower limit are set automatically to various values associated with the customer's present or past checking and savings account balances, while, in other instances, these values are user-defined.

After the checking account values are set, the customer may receive a deposit, which may raise the value of the checking account balance above the upper limit, as illustrated by block 30. As illustrated by block 32, the balance amount above the upper limit is then transferred to the customer's savings account. The process illustrated in blocks 30 and 32 will occur until a new cycle begins as illustrated by block 50.

On the other hand, the customer's checking account may be debited, which may cause the balance of the checking account to fall below the lower limit, as illustrated in block 40. When the balance falls below the lower limit, money is swept from the savings account into the checking account until the checking account balance reaches the desired target balance (or until there is no money left in the savings account, whichever occurs first), as illustrated in block 42. As illustrated in block 44, in one embodiment, after six sweeps, or some other pre-determined number of sweeps, has occurred in one cycle, all of the money in the savings account is swept into the checking account during the sixth (or other pre-determined number) sweep. As illustrated by block 34, after a new cycle, such as a new month, begins, all of the balance in the checking account that is above the upper limit is transferred to the savings account. The process then repeats itself for the new cycle.

It should be appreciated that, although embodiments of the present invention are generally described herein in terms of a checking and savings accounts, other embodiments of the invention involve other accounts that may not be traditionally thought of as checking or savings accounts. As used herein, the term “savings account” includes money market accounts (MMAs). In some embodiments, the savings account is located within the country, while, in other embodiments, the savings account may be located in a foreign country. In some embodiments, at least a portion of the funds in the savings account is insured by the Federal Deposit Insurance Corporation (FDIC) or other entity, while, in other embodiments, the funds are not. Furthermore, although some embodiments are described herein as specifically being offered to small businesses, other embodiments of the invention are used in conjunction with the accounts of other businesses or individuals.

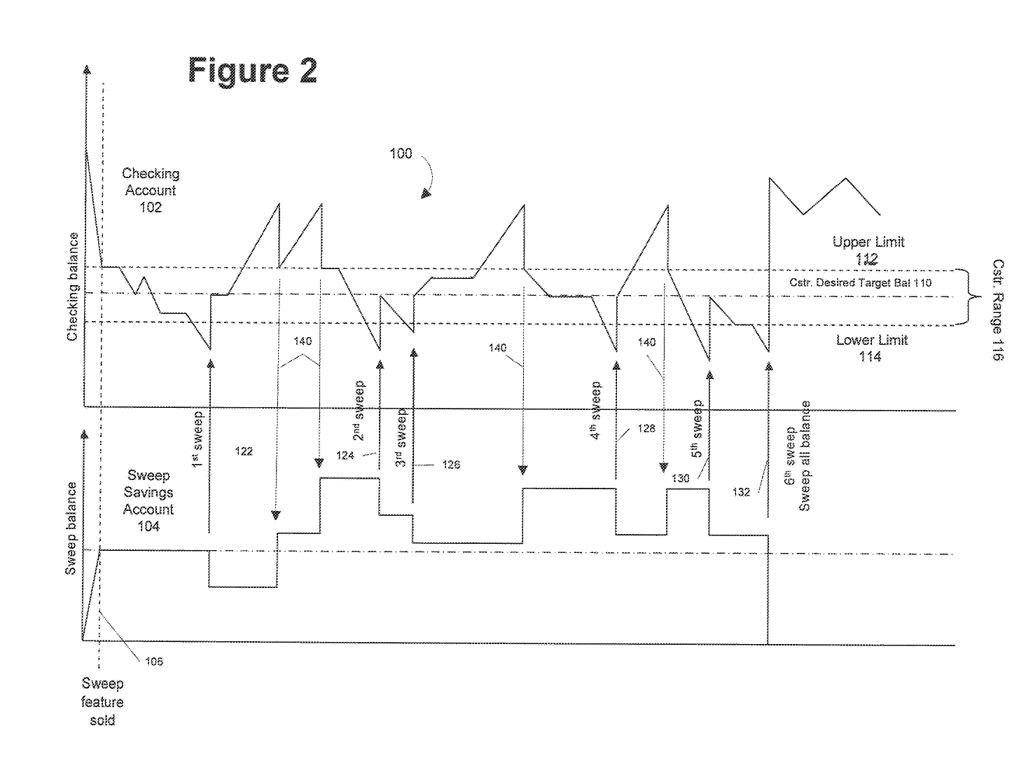

FIG. 2 illustrates an example of how the sweep process will work during a particular cycle, in accordance with one embodiment of the invention. FIG. 1 demonstrates the interaction between the amount of funds in a checking account 102 and the amount of funds in a sweep savings account 104. Within the checking account 102, the customer will elect the desired target balance 110, as well as the checking account 102, upper limit 112 and lower limit 114 balances. The difference in the upper limit 112 and the lower limit 114 is the customer range 116. These values will be determined when the customer elects to enroll in the sweep feature or if the customer elects to change the values at some point in the time after enrolling in the sweep feature. In one embodiment, the customer enters these values using a website provided on the Internet and accessed by a personal computing device. In other embodiments, as described above, these values may be defaulted to some automatically determined values based on information about the current balance or balance history of the customer's checking and/or savings accounts.

In the exemplary embodiment illustrated in FIG. 2, the customer has elected the checking account 102 balance on the day the customer signed up for the sweep feature as the upper limit 112. It shall be understood that the customer can choose any level for the desired target balance 110, upper limit 112, and lower limit 114, and that the upper limit 112 need not be the current balance in the checking account when the customer signed up for the savings sweep program. As previously discussed, one or all of either the desired target balance 110, upper limit 112, and lower limit 114 may be set automatically by the bank based on any one of a number of variables associated with the checking and savings accounts at the bank.

In this particular example, as the cycle time passes and the customer begins spending money, the amount of money in the checking account 102 begins to decline below both the desired target balance 110 and the lower limit 114, which will trigger the 1^{st} sweep 122. During the 1^{st} sweep 122, money is removed from the sweep savings account 104 and sent to the checking account 102. This restores the checking account 102 to the customer's desired target balance 110. Next, when the funds in the checking account surpass the upper limit 112, the excess money in the checking account 102 (the amount of money over the upper limit) is transferred back to the sweep savings account 104, as illustrated by the transfers 140 in FIG. 2. This, however, is not considered a “sweep,” as the term is used herein, because a sweep generally is defined herein as the transfer of funds from the sweep savings account 104 to the checking account 102. Although the embodiments illustrated herein generally involve transferring the money in the checking account in excess of the upper limit to the savings account in the event that the checking account balance exceeds the upper limit, in other embodiments, the amount of money in the checking account in excess of the target balance is transferred to the savings account in the event that the checking account balance exceeds the upper limit.

As illustrated by the 2^{nd} sweep 124, the funds are again reduced below the lower limit. As a result, money is swept from the sweep savings account 104 into the checking account 102 until the checking account 102 balance reaches the customer's desired target balance 110. Again, the 3^{rd} sweep 126 is performed after the checking account 102 balance falls below the lower limit 114. Money from the sweep savings account 104 is moved to the checking account 102 until the checking account 102 reaches the desired target balance 110. The money in the checking account 102 continues to increase until it once again surpasses the upper limit 112, whereafter the excess cash in the checking account 102 is deposited back into the sweep savings account 104 through the transfer 140. The 4^{th} sweep 128 and 5^{th} sweep 130 occur in the same way as sweeps 1 through 3, with the funds in the checking account 102 falling below the lower limit 114 and the bank sweeping money from the sweep savings account 104 into the checking account 102 until the checking account 102 funds reach the customer's desired target balance 110.

If the 6^{th} sweep 132 occurs within the current cycle time, which in this case is a one month time period, then as illustrated in FIG. 2, the illustrated embodiment of the system will move all of the money in the sweep savings account 104 to the checking account 102, regardless of the balance in the checking account 102. Thereafter, the sweep savings account 104 will have a balance of zero dollars until the next cycle begins and the balance in the checking account exceeds the upper limit. It is important to note that, in the illustrated embodiment, after the 6^{th} sweep 132 occurs in a cycle, no more automatic sweeps will be allowed until the start of the new cycle. In some instances, the limit of six sweeps per cycle may be different, thus the number of allowable sweeps occurring may be less or more than six. In one embodiment, an unlimited amount of sweeps is possible.

At the start of the new cycle, the amount of cash, if any, in the checking account 102 that is above the upper limit 112 is transferred 140 into the sweep savings account 104. In this exemplary embodiment, the customer will again have six sweeps available in the new cycle to move money from the sweep savings account 104 into the checking account 102 when the balance of the checking account 102 falls below the lower limit 114.

It should be appreciated that a system having an upper limit 112 and a lower limit 114 can be particularly useful where regulations limit the number of sweeps per cycle since, compared to only having a single target value without an upper and lower limit, since the system allows the user to better control how quickly the pre-determined number of sweeps occur in each cycle. In this way, the customer can better maximize the amount of interest accrued in the savings account.

In one embodiment, the customer will have the option of changing the desired target balance 110, the upper limit 112, and the lower limit 114 at any time during the process or, in other embodiments, one or more periodic pre-determined times. This ensures that as an SBA's, or other customer's, revenue and cost stream change on a month-to-month or day-to-day basis, the SBA, or other customer, will be able to maximize the interest income they can earn under the Regulation D guidelines. In one embodiment, the customer will even be allowed to change the desired target balance 110, the upper limit 112 and the lower limit 114 during any point within the current cycle. Such an embodiment gives a customer who is using too few or too many sweeps during the beginning of the month the ability to re-adjust the selections to better distribute the sweeps throughout the cycle, in order to maximize the interest income earned in the sweep savings account 104.

In one embodiment of the invention, the transfers of funds from the checking account 102 to the sweep savings account 104 and/or sweeps from the sweep savings account 104 to the checking account 102 occur overnight. Making the transactions overnight after the end of business for the day allows the bank to complete any deposits or credits for the checking account 102 or the sweep savings account 104 before a transfer of funds or a sweep is performed. Variations in the deposits and credits throughout the day could potentially effect whether or not a transfer of funds or a sweep should occur. Therefore, in one embodiment, it may be desirable to make the determination if a sweep is necessary after all of the deposits and credits for the day have been taken into account. In other embodiments of the invention, the transfer of funds and/or the sweep occurs at any time or at other times during the day.

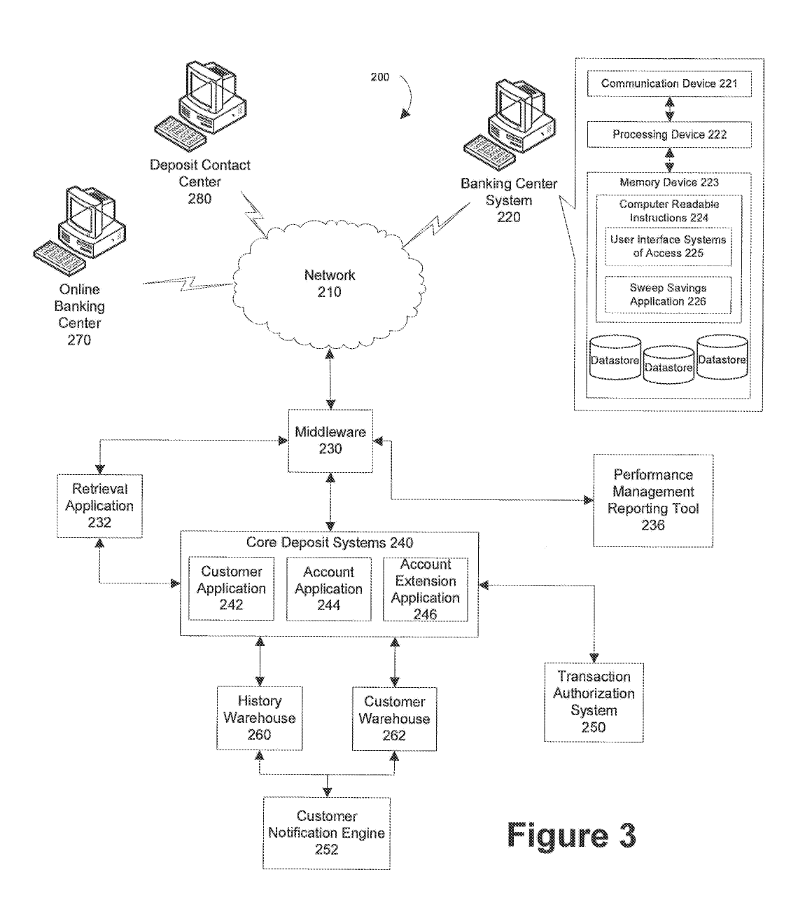

FIG. 3 illustrates a banking environment 200 in which one embodiment of the present invention exists. As illustrated in FIG. 3, the Banking Center Systems 220 are operatively coupled, via a network 210, to the computing systems, websites, servers, or the like, of one or more computer systems within the bank. The network 210 may be a global area network (GAN), such as the Internet, a wide area network (WAN), a local area network (LAN), or any other type of network or combination of networks. The network 210 may provide for wireline, wireless, or a combination of wireline and wireless communication between devices in the network 210.

As illustrated in FIG. 3, the Banking Center Systems 220 generally comprises a communication device 221, a processing device 222, and a memory device 223. The processing device 222 is operatively coupled to the communication device 221 and the memory device 223. The processing device 222 uses the communication device 221 to communicate with the network 210. As such, the communication device 221 generally comprises a modem, server, or other device for communicating with other devices on the network 210, and a display, mouse, keyboard, microphone, and/or speakers for communicating with one or more users. As further illustrated in FIG. 3, the Banking Center Systems 220 include computer-readable instructions 224 stored in the memory device 223, which include the computer-readable instructions 224 of the user interface systems of access 225 and the sweep savings application 226. The systems of access 225 user interface is used to open, maintain, and service various accounts held at the bank. The systems of access 225 comprises a computer program that instructs the processing device 222 to pull and push data and records for these accounts from multiple computer systems and applications. In other embodiments of the invention the sweep savings application 226 may be stored on other systems and accessed through the systems of access 225 user interface.

Generally, bank representatives use the Banking Center Systems 220 to enter data when customers apply for various bank products. The Banking Center Systems 220 are also used to service customer requests on the products that the customers already own. As specifically applied to savings sweep accounts, when a customer walks into a bank branch, a bank representative uses the systems of access 225 to connect to other bank applications for setting up the sweep account, managing the set-up configurations, transferring the balances between the checking and savings accounts when necessary, recording the transactions, notifying the appropriate customers, employees, and applications, etc., for the sweep savings application 226.

The Banking Center Systems 220 use the systems of access 225 to connect to the savings sweep application 225, which is used for setting up or editing a customer's savings sweep account. The systems of access 225 uses the middleware 230 to access applications and systems with which the Banking Center Systems 220 are not directly compatible. Middleware 230 is computer software that connects software components or applications working on different operating systems. The middleware 230 temporarily stores data going to and coming from other systems and applications throughout the bank, such as the core deposit systems 240, in order to facilitate making changes to data stored in those systems and applications.

The core deposit systems 240 can contain any number of systems of records or other data storage systems. A system of record is an information storage system, which is the authoritative data source for a portion of information in the system. The core deposit systems 240 comprise a set of processes for collecting, aggregating, matching, consolidating, quality-assuring, persisting and distributing data through the organization to ensure consistency and control in the maintenance and application of all of the accounts of each of the bank's customers. The core deposit systems 240 may use data retrieval applications 232 to push data related to the core deposit systems 240 to the rest of the bank's systems.

In one embodiment of the invention, the core deposit systems 240 contain a customer application 242, an account application 244, and an account extension application 246. The customer application 242 stores the data associated with the customer records, the account application 244 stores the data associated with each customer's account, while the account extension application 246 stores product specific rules and customer behavior information. When an account is opened or account information is changed, the middleware 230 or retrieval application 232 accesses the customer application 242 and sends to it any new data or changes to the customer information for storage. When any changes to the type of account or to the funds in the account are made, the systems of access 225 will access the account application 244 and send it the changes for storage. Likewise, when any changes to the rules of a specific product are made, such as the upper limit 112 for a sweep savings account 104, the systems of access 225 will access the account extension application 246 and send it the changes for storage.

The core deposit systems 240 are tied to a transaction authorization system 250, which controls and monitors the balances for all of the accounts. Therefore, when a sweep is made from the sweep savings account 104 to the checking account 102, the transaction authorization system 250 will check to determine if the transaction is authorized and will check the balances in the account against any other transactions, which might impact the proposed sweep. Therefore, the transaction authorization system 250 serves as a monitoring system for the debits and credits associated with the accounts.

The core deposit systems 240 are also tied to a history warehouse 260 and customer warehouse 262, where data is stored that can be used to display it to bank representatives and customers when necessary. The history warehouse 260 is a history of all of the transactions that occur in the accounts. The customer warehouse 262 pulls out pieces of key data from the core deposit systems 240 and the history warehouse 260 to focus on generating a database to examine customer behavior at the customer level as opposed to customer behavior at an account level. The warehouses are connected to a customer notification engine 252, which sends out notices to customers or bank representatives associated with particular accounts when appropriate data related to those accounts builds up in the warehouses. For example, after 3 sweeps have occurred within the first week of a cycle, the customer notification engine 252 may send out a notification to the customer that 3 sweeps have already occurred and the customer might want to change the settings related to the sweep savings account 104 for that cycle.

When a bank associate is setting up a sweep savings account 104, the associate will use the Banking Center System's 220 systems of access 225 to enter in the customer information along with the customer preferences, including the desired target balance 110, the upper limit 112, and the lower limit 114. The information will be temporarily stored in the middleware 230, while the middleware 230 accesses the core deposit systems 240, either directly or through the retrieval application 232. The customer data is then stored in the customer application 242, while the account information is stored in the account application 244. The rules associated with when to sweep from the sweep savings account 104 to the checking account 102, as well as when funds move from the checking account 102 to the savings account 104, are stored in the account extension application 246. When a customer makes changes to the sweep savings account 104 preferences the middleware 230 will access the core deposit systems 240, temporarily store the current settings, and display them on the systems of access 225 so the customer may make any desired changes. In some instances, the middleware 230 will use the retrieval application 232 to pull and push data to and from the core deposit systems 240.

After the customer's account is set up and the preferences for the desired target balance 110, upper limit 112, and the lower limit 114 are determined, the actual sweeps may be performed. In the case of the example displayed in FIG. 2, when the balance in the checking account 102 falls below the lower limit 114 the account application 244 will recognize that a sweep is necessary based on the preferences stored in the account extension application 246. Then the account application 244 will link the checking account 102 with the sweep savings account 104. The transaction authorization system 250 will determine the amount of funds to move between the accounts. The account application 244 will then make the sweep and unlink the checking account 102 and the sweep savings account 104. The transaction will be stored in the history warehouse 260, and then the customer notification engine 252 will send the details of the sweep to the appropriate customers.

This process is repeated whenever the balance in the checking account 102 is above the upper limit 112 or below the lower limit 114, after the 6^{th} sweep 134 has occurred, or at the beginning of a new cycle.

Whenever a sweep occurs in the banking environment 200, the account application 244 will interface with the transaction authorization system 250 to make sure the funds are available and to conduct the transaction. After the transaction is verified, the account application 244 will transfer the funds from the sweep savings account 104 to the checking account 102. This process also occurs when funds are being moved from the checking account 102 to the sweep savings account 104.

In the meantime, the customer notification engine 252 may notify the customer that a sweep related to his/her account has taken place. This notification will supply the customer with information that the transaction had occurred or if an unauthorized transaction has taken place. In some embodiments of the invention, the customer may choose when to get notifications of activity related to the customer's account; however, in other embodiments the notifications will be provided by the bank. Therefore, whenever a transaction, new account, change in account settings, or any other important function occurs, the customer notification engine 252 will notify the appropriate contact.

The performance management reporting tool 236 tracks product sales in the banking centers and other channels, and communicates with other bank systems to help determine incentive pay for the product sellers.

FIG. 3 illustrates that the Banking Center Systems 220 and other bank systems are operatively connected to the Online Banking Center 270 and the Deposit Contact Center 280. In this environment, a customer may access their checking account 102 and sweep savings account 104 through the Online Banking Center 270 over a network 210. The customer may have a user interface systems of access for the Online Banking Center 270. From the user interface, the customer may make the same changes to the customer preferences and information that can be made using the systems of access 225 at the Banking Center Systems 220. Any changes made by the customer are stored in the middleware 230 and then updated in the core deposit systems 240. The customer may also make personal account inquiries about the interest accrued and paid in the accounts through the systems of access for the Online Banking Center 270.

The customer may also make the same changes that are made online and through the Banking Center Systems 220 by contacting the Deposit Contact Center 280, which is a call center staffed with bank representatives. The Deposit Contact Center 280 representatives may perform the same functions that the Banking Center representatives do using a systems of access that is the same or similar to the systems of access 225 that is used at the Banking Center Systems 220. The customer may receive information regarding accounts, including sweep accounts and other services, as well as update their preferences by speaking to a Deposit Contact Center 280 representative over the phone.

Representatives using the Banking Center Systems 220, representatives at the Deposit Contact Center 280, or customers using the Online Banking Center 270 will be able to review any changes made by anyone else to the customer's account.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system for linking customer checking and savings accounts within a financial institution to distribute funds between the accounts, the system comprising:
one or more memory devices; and
one or more processing devices operatively coupled to the one or more memory devices, wherein the one or more processing devices are configured to execute computer-readable program code to:
receive input values for an upper limit, a lower limit, and a target balance for a balance in a checking account, wherein the target balance associated with the checking account is greater than the lower limit and less than the upper limit;
transferring a portion of checking funds above the upper limit from the checking account to an interest bearing savings account when the checking funds in the checking account reach a value greater than the upper limit until a new balance of the checking account is equal to the target balance; and
sweeping a portion of savings funds from a savings account into the checking account when the balance of the checking account falls below the lower limit until the new balance of the checking account is equal to the target balance.

2. The system of claim 1, wherein the one or more processing devices are further configured to transfer the portion of the checking funds from the checking account to the interest bearing savings account when the first funds in the first account are above or equal to the upper limit.

3. The system of claim 1, wherein the one or more processing devices configured to transfer the portion of the checking funds from the checking account to the interest bearing account when the checking funds in the checking account are above or equal to the upper limit at one or more specific pre-determined times during a day.

4. The system of claim 1, wherein values of the upper limit, the lower limit, and the target balance are defined by an owner of the checking account.

5. The system of claim 1, wherein the one or more processing devices are configured to automatically determine values for the upper limit, the lower limit, or the target balance based at least partially on maximizing interest generated by the interest bearing savings account.

6. The system of claim 1, wherein the one or more processing devices are configured to automatically determine values for the upper limit, the lower limit, or the target balance based at least partially on information about the checking account.

7. The system of claim 1, wherein the one or more processing devices are configured to sweep the portion of the savings funds from the interest bearing savings account into the checking account a maximum pre-determined number of times within a cycle, and wherein the processing device is configured to sweep all of the savings funds in the interest bearing savings account into the checking account when the maximum pre-determined number of sweeps occurs within the cycle.

8. A computer program product for linking customer checking and savings accounts within a financial institution to distribute funds between the accounts, the computer program product comprising at least one non-transitory computer-readable medium having computer-readable program code portions embodied therein, the computer-readable program code portion comprising:
an executable portion configured for receiving input values for an upper limit, a lower limit, and a target balance for a balance in a checking account, wherein the target balance associated with the checking account is greater than the lower limit and less than the upper limit;
an executable portion configured for transferring a portion of checking funds above the upper limit from the checking account to an interest bearing savings account when the checking funds in the checking account reach a value greater than the upper limit until a new balance of the checking account is equal to the target balance; and
an executable portion configured for sweeping a portion of savings funds from a savings account into the checking account when the balance of the checking account falls below the lower limit until the new balance of the checking account is equal to the target balance.

9. The computer program product of claim 8, further comprising:
an executable portion configured for transferring the portion of the checking funds from the checking account to the interest bearing savings account when the first funds in the first account are above or equal to the upper limit.

10. The computer program product of claim 8, further comprising:
an executable portion configured for transferring the portion of the checking funds from the checking account to the interest bearing account when the checking funds in the checking account are above or equal to the upper limit at one or more specific pre-determined times during a day.

11. The computer program product of claim 8, wherein values of the upper limit, the lower limit, and the target balance are defined by an owner of the checking account.

12. The computer program product of claim 8, further comprising:
an executable portion configured for automatically determining values for the upper limit, the lower limit, or the target balance based at least partially on maximizing interest generated by the interest bearing savings account.

13. The computer program product of claim 8, further comprising
an executable portion configured for automatically determining values for the upper limit, the lower limit, or the target balance based at least partially on information about the checking account.

14. The computer program product of claim 8, further comprising
an executable portion configured for sweeping the portion of the savings funds from the interest bearing savings account into the checking account a maximum pre-determined number of times within a cycle, and wherein the processing device is configured to sweep all of the savings funds in the interest bearing savings account into the checking account when the maximum pre-determined number of sweeps occurs within the cycle.

15. A method for linking customer checking and savings accounts within a financial institution to distribute funds between the accounts, the method comprising:
receiving, by a processing device, input values for an upper limit, a lower limit, and a target balance for a balance in a checking account, wherein the target balance associated with the checking account is greater than the lower limit and less than the upper limit;
transferring, by a processing device, a portion of checking funds above the upper limit from the checking account to an interest bearing savings account when the checking funds in the checking account reach a value greater than the upper limit until a new balance of the checking account is equal to the target balance; and
sweeping, by a processing device, a portion of savings funds from a savings account into the checking account when the balance of the checking account falls below the lower limit until the new balance of the checking account is equal to the target balance.

16. The method of claim 15 further comprising:
transferring, by a processing device, the portion of the checking funds from the checking account to the interest bearing savings account when the first funds in the first account are above or equal to the upper limit.

17. The method of claim 15 further comprising:
transferring, by a processing device, the portion of the checking funds from the checking account to the interest bearing account when the checking funds in the checking account are above or equal to the upper limit at one or more specific pre-determined times during a day.

18. The method of claim 15, wherein values of the upper limit, the lower limit, and the target balance are defined by an owner of the checking account.

19. The method of claim 15 further comprising:
determining automatically, by a processing device, values for the upper limit, the lower limit, or the target balance based at least partially on maximizing interest generated by the interest bearing savings account.

20. The method of claim 15 further comprising:
determining automatically, by a processing device, values for the upper limit, the lower limit, or the target balance based at least partially on information about the checking account.

21. The method of claim 15 further comprising:
sweeping, by a processing device, the portion of the savings funds from the interest bearing savings account into the checking account a maximum pre-determined number of times within a cycle, and wherein the processing device is configured to sweep all of the savings funds in the interest bearing savings account into the checking account when the maximum pre-determined number of sweeps occurs within the cycle.
